(19) United States
(12) Patent Application Publication
(10) Pub. No.: US 2008/0254971 A1
(43) Pub. Date: Oct. 16, 2008

(54) PROCESS FOR RENDERING AN OXYGEN-SENSITIVE CATALYST INERT

(75) Inventors: Martin Ehrig, Koeln (DE); Dirk Gerhard, Erlangen (DE); Mitja Medved, Erlangen (DE); Katharina Obert, Erlangen (DE); Peter Wasserscheid, Erlangen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 12/101,010

(22) Filed: Apr. 10, 2008

(30) Foreign Application Priority Data
Apr. 13, 2007 (DE) 10 2007 017 872.9

(51) Int. Cl. B01J 31/02

(52) U.S. Cl. 502/164; 502/167

(57) ABSTRACT

A process for rendering an oxygen-sensitive heterogeneous catalyst (s-cat) inert to oxygen, as well as a heterogeneous catalyst that is not sensitive to oxygen, is disclosed. The surface of the s-cat is wetted with an ionic liquid. The ionic liquid firmly adhering to the surface of the catalyst forms a film, which protects the s-cat from reactions with oxygen.

This application claims the priority of German Patent Document No. 10 2007 017 872.9, filed Apr. 13, 2007, the disclosure of which is expressly incorporated by reference herein.

### BACKGROUND AND SUMMARY OF THE INVENTION

The invention related to a process for rendering an oxygen-sensitive heterogeneous catalyst (s-cat) inert to oxygen as well as a heterogeneous catalyst that is not sensitive to oxygen.

Heterogeneous catalysts are frequently used in the chemical industry to support the transformation of starting materials into specific products. The catalysts reduce the energy demand required for the reaction. In addition, they increase the yield of the reaction because they favor the formation of the desired products in a targeted manner. Considered especially advantageous are catalysts that possess high catalytic activity and are inexpensive and environmentally compatible, i.e., not toxic and easy to handle, are therefore not self-igniting (pyrophoric) and also have high mechanical, thermal and chemical stability.

Many heterogeneous catalysts that are characterized by their high catalytic activity with respect to certain chemical reactions show marked pyrophoric behavior; with contact with oxygen they thus quickly forfeit their functionality. The prior art handles this by deactivating these types of catalysts through passivation to thereby protect them from undesired reactions with oxygen. Before use the deactivated catalysts have to be reactivated with considerable effort. Examples of catalysts of this type are iron catalysts for ammonia synthesis, iron chrome catalysts and copper zinc catalysts for the water gas shift reaction.

Using the example of pyrophoric Raney nickel, the problems encountered when using oxygen-sensitive catalysts will be described in more detail in the following. Raney nickel is a heterogeneous catalyst comprised of fine grains of a nickel-aluminum alloy and used predominantly in industry as a hydrogenating catalyst for instance in the hydrogenation of alkene, alkine, nitrile, carbonyl, nitroso or nitro compounds. In contrast to hydrogenating catalysts with a precious-metal basis (e.g., platinum, palladium, ruthenium or rhodium catalysts), Raney nickel is considerably more cost effective with a comparatively high catalytic activity. For this reason, it is utilized in many cases despite its self-ignitability and the involved handling resulting from this fact.

Due to its self-ignitability Raney nickel is normally sold and stored suspended in water. Water adhering to the fine metal particles complicates the exact dosing of the catalyst and must be removed before use, for example by vacuum drying, in order to prevent the formation of several liquid phases especially with use in organic solvents. After the water is removed, the Raney nickel must be stored before use using protective gas and after use in an inert environment separated from solvents and products. Using Raney nickel in connection with easily ignitable, organic solvents is especially problematic.

Therefore, the objective of the present invention is disclosing a process of the type cited at the outset through which an oxygen-sensitive catalyst (s-cat) can be used less problematically and with less expense than is possible according to the prior art.

The stated objective is attained in terms of the process according to the invention in that the surface of the s-cat is wetted with an ionic liquid.

### DETAILED DESCRIPTION OF THE EXEMPLARY EMBODIMENTS

Ionic liquids are low-melting organic salts with melting points between 100 and −90° C., whereby most of the known ionic liquids are already present in a liquid form at room temperature. Ionic liquids are formed from positive (cations) and negative ions (anions), but are charge-neutral overall. Both the anions as well as the cations of an ionic liquid can be of different types. They are monovalent for the most part, but may also have higher valences, which is why the number of anions is not necessarily the same as the number of cations. In contrast to conventional molecular liquids, ionic liquids are entirely ionic and therefore exhibit new and unusual properties. Ionic liquids can be adapted comparatively easily in terms of their properties to given technical problems due to the variation of the structure of the anion and/or cation as well as due to the variation of their combinations. Thus, for example, the density and mixing behavior with other substances can be influenced or adjusted within wide limits in the case of ionic liquids by the selection of ions. For this reason, they are also frequently referred to as so-called “designer solvents.” In the case of conventional molecular liquids, on the other hand, only one variation of the structure is possible. An additional advantage of ionic liquids as compared to conventional molecular liquids is that they have no measurable vapor pressure. This means that as long as they do not reach their decomposition temperature, which is often over 200° C., the smallest traces of them do not vaporize even in a high vacuum.

Because of the ionic bond, the ionic liquid adheres very firmly, even as an extremely thin film, on the surface of the catalyst and protects it from reactions with oxygen. This protective effect is retained even at higher temperatures (e.g., 200° C.). The invention makes it possible to transform a catalyst that is very hard to handle because of its oxygen sensitivity into a form that is easier to use, which can also be stored for a longer period of time without any difficulty in open-air systems. In addition, the process of rendering inert in accordance with the invention reduces the tendency to deactivate the catalyst, which is why it remains serviceable over a longer period of time.

In order to achieve the wetting of the surface of the s-cat, the s-cat is expediently suspended in the ionic liquid. By filtering off excess ionic liquid, a catalyst is obtained whose surface is coated with a film of ionic liquid, which protects the s-cat from undesired reactions with oxygen.

The inventive process is suitable for rendering all possible oxygen-sensitive heterogeneous catalysts inert to reactions with oxygen. However, it is preferably used to render self-igniting (pyrophoric) and/or metal-based s-cats inert.

The inventive process is particularly advantageous for rendering Raney nickel inert.

As experience shows, ionic liquids have only little or no influence on the catalytic activity of the s-cat. As a result, a catalyst created by rendering an s-cat inert in accordance with the invention can be used in the same reactions as the s-cat itself.

If suitable conditions are selected for a reaction, which depend upon the type of s-cat, the ionic liquid used for rendering inert, as well as the solvent used for the reaction, the ionic liquid will remain adhered to the surface of the s-cat and will still wet it even after the end of the reaction. In these cases, the catalyst that is rendered inert can be separated from the solvent and the products, put into intermediate storage if necessary and be used again for a new reaction.

Ionic liquids selected from the group of the following ionic liquids, amongst others, may be used to carry out the inventive process. The cation(s) are selected from the group formed by the following substances:

a) quarternary ammonium cations of the general formula [NRR¹R²R³]⁺;
b) quarternary phosphonium cations of the general formula [PRR1R2R3]⁺;
c) imidazolium cations of the general formula

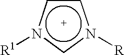

wherein the imidazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;

d) pyridinium cations

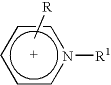

wherein the pyridine core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;

e) pyrazolium cation

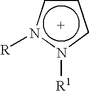

wherein the pyrazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;

f) triazolium cation

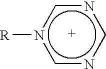

wherein the triazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
and in the general formulae the radicals R¹, R² and R³ are selected independent of one another from the group formed by the following substances:
hydrogen;
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
   and in the general formulae the radical R is selected from the group formed by the following substances:
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms; aryl-, aryl-C₁-C₆ alkyl groups with 5 to 12 carbon atoms in aryl residue, which can be substituted with at least one C₁-C₆ alkyl group and/or a halogen atom;
   and the anion(s) may be selected from the group formed by the following substances:

a) tetrafluoroborate ([BF₄]—),

b) tetrachloroborate ([BCl₄]—),

c) hexafluorophosphate ([PF₆]—),

d) hexafluoroantimonate ([SbF₆]—),

e) hexafluoroarsenate ([AsF₆]—),

f) sulfate ([SO₄]²⁻),

g) carbonate ([CO₃]²⁻),

h) fluorosulfonate,

i) [R′—COO]⁻,

j) [R′—SO₃]⁻,

k) [R′—SO₄]⁻,

l) [R′₂PO₄]⁻,

m) [Tetrakis-(3,5-bis-(trifluoromethyl)-phenyl)borate] ([BARF]), and

n) [(R′—SO₂)₂N]⁻;

wherein R′ is a linear or branched aliphatic or alicyclic alkyl residue or C₅-C₁₈ aryl residue or C₅-C₁S-aryl-C₁-C₆ alkyl residue or C₁-C₆-alkyl-C₅-C₁₈ aryl residue that contains 1 to 12 carbon atoms and which can be substituted by halogen atoms or oxygen atoms.

Especially preferred as an ionic liquid for carrying out the inventive process is one that has bistrifluoromethylsulfonylimide as an anion such as 1-butyl-3-methylimidazolium bistrifluoromethylsulfonylimide ([BMIM][NTf₂]), for example.

In addition, the invention relates to a heterogeneous catalyst that is not sensitive to oxygen.

The claimed catalyst is characterized in that it is comprised of an oxygen-sensitive heterogeneous catalyst (s-cat) whose surface is wetted with an ionic liquid.

The s-cat is preferably a self-igniting (pyrophoric) and/or metal-based catalyst, for example Raney nickel, which has proven to be especially suitable in practice.

In terms of the ionic liquid used for wetting the surface of the s-cat, it is preferred that an ionic liquid selected from the following group of ionic liquids be used. The ionic liquid is selected from the group of the following ionic liquids to which the following applies:

ionic liquids are substances of the general formula aA<m+>bB<n->,

wherein a and b are whole numbers and m=1 or m=2 and n=1 or n=2 and a*m=b*n
and the cation A used is selected from the group formed by the following substances:

a) quarternary ammonium cations of the general formula [NRR¹R²R³]⁺;

b) quarternary phosphonium cations of the general formula [PRR1R2R3]⁺;

c) imidazolium cations of the general formula

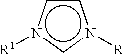

wherein the imidazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;

d) pyridinium cations

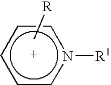

wherein the pyridine core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;

e) pyrazolium cation

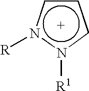

wherein the pyrazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;

f) triazolium cation

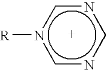

wherein the triazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups; and in the general formulae the radicals R¹, R² and R³ are selected independent of one another from the group formed by the following substances:
hydrogen;
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
   and in the general formulae the radical R is selected from the group formed by the following substances:
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
   and the anion B used is selected from the group formed by the following substances:

a) tetrafluoroborate ([BF₄]⁻),

b) tetrachloroborate ([BCl₄]⁻),

c) hexafluorophosphate ([PF₆]⁻),

d) hexafluoroantimonate ([SbF₆]⁻),

e) hexafluoroarsenate ([AsF₆]⁻),

f) sulfate ([SO₄]²⁻),

g) carbonate ([CO₃]²⁻),

h) fluorosulfonate,

i) [R′—COO]⁻,

j) [R′—SO₃]⁻,

k) [R′—SO₄]⁻,

l) [R′₂PO₄]⁻,

m) [Tetrakis-(3,5-bis-(trifluoromethyl)-phenyl)borate] ([BARF]), and

n) [(R′—SO₂)₂N]⁻;

wherein R′ is a linear or branched aliphatic or alicyclic alkyl residue or C₅-C₁₈ aryl residue or C₅-C₁₈-aryl-C₁-C₆ alkyl residue or C₁-C₆-alkyl-C₅-C₁₈ aryl residue that contains 1 to 12 carbon atoms and which can be substituted by halogen atoms or oxygen atoms.

Especially preferred in this case is an ionic liquid that has bistrifluoromethylsulfonylimide as an anion such as 1-butyl-3-methylimidazolium bistrifluoromethylsulfonylimide ([BMIM][NTf₂]), for example.

The invention will be explained in greater detail in the following on the basis of an exemplary embodiment.

The exemplary embodiment relates to rendering commercially available Raney nickel inert as well as to the use of the Raney nickel that has been rendered inert in accordance with the invention for the heterogeneously catalyzed hydrogenation of 2,3-dimethyl-1,3-butadiene to 2,3-dimethyl-1-buten, 2,3-dimethyl-2-buten and 2,3-dimethylbutane.

Two parts by weight of Raney nickel, which is commercially available as a suspension with oxygen-free water, are mixed in a first step with three parts by weight of the ionic liquid 1-butyl-3-methylimidazolium bistrifluoromethylsulfonylimide ([BMIM][NTf₂]). The ionic liquid displaces the water from the surface of the Raney nickel and forms a layer there, which renders the catalyst inert to oxygen, but does not affect its catalytic activity substantially. Then the water introduced together with the Raney nickel is removed from the mixture by means of a rotary evaporator at a reduced pressure of approx. 50 mbar and at a temperature of approx. 50° C.

The hydrogenation of 2,3-dimethyl-1,3-butadiene is performed discontinuously in a stirred tank reactor, such as a high-pressure autoclave, which is equipped with a gas feed stirrer as well as a temperature sensor and pressure sensor. 0.6 g of the Raney nickel treated in the manner described above, which under normal environmental conditions is inert to atmospheric oxygen, is weighed into the reactor without the exclusion of air. Then 200 g cyclohexane and 3 g of the starting material 2,3-dimethyl-1,3-butadiene are added to the catalyst before the reactor is closed. After flushing the gas space above the liquid level with an inert gas, hydrogen is introduced into the reactor and the hydrogen pressure is raised to 30 bar. The temperature in the reactor is raised to 100° C. before the gas feed stirrer is started up. After a reaction time of less than one hour, the 2,3-dimethyl-1,3-butadiene is completely transformed into the products 2,3-dimethyl-1-buten, 2,3-dimethyl-2-buten and 2,3-dimethylbutane.

Upon conclusion of the reaction, the Raney nickel rendered inert that was used can be separated in air from the cyclohexane as well as from the products using filtration and be stored for several weeks in air, without self-igniting.

The exemplary embodiment makes clear that the catalyst created by means of the inventive process is equivalent in terms of its chemical effect to commercially available Raney nickel, but can be handled much more simply in the process.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for rendering an oxygen-sensitive heterogeneous catalyst (s-cat) inert to oxygen, wherein a surface of the s-cat is wetted with an ionic liquid.

2. The process according to claim 1, wherein the wetting of the surface of the s-cat is achieved by suspension of the s-cat in the ionic liquid.

3. The process according to claim 1, wherein a self-igniting (pyrophoric) catalyst is used as the s-cat.

4. The process according to claim 1, wherein a metal-based catalyst is used as the s-cat.

5. The process according to claim 4, wherein Raney nickel is used as the s-cat.

6. The process according to claim 1, wherein the ionic liquid is selected from the group of the following ionic liquids to which the following applies:
the cation(s) are selected from the group formed by the following substances:
a) quarternary ammonium cations of the general formula [NRR¹R²R³]⁺;
b) quarternary phosphonium cations of the general formula [PRR1R2R3]⁺;
c) imidazolium cations of the general formula 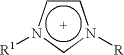
wherein the imidazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
d) pyridinium cations 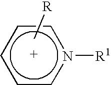
wherein the pyridine core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
e) pyrazolium cation 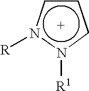
wherein the pyrazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
f) triazolium cation 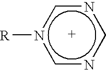
wherein the triazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
and in the general formulae the radicals R¹, R² and R³ are selected independent of one another from the group formed by the following substances:
hydrogen;
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
and in the general formulae the radical R is selected from the group formed by the following substances:
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
and the anion(s) are selected from the group formed by the following substances:
a) tetrafluoroborate ([BF₄]⁻),
b) tetrachloroborate ([BCl₄]⁻),
c) hexafluorophosphate ([PF₆]⁻),
d) hexafluoroantimonate ([SbF₆]⁻),
e) hexafluoroarsenate ([AsF₆]⁻),
f) sulfate ([SO₄]²⁻),
g) carbonate ([CO₃]²⁻),
h) fluorosulfonate,
i) [R′—COO]⁻,
j) [R′—SO₃]⁻,
k) [R′—SO₄]⁻,
l) [R′₂PO₄]⁻,
m) [Tetrakis-(3,5-bis-(trifluoromethyl)-phenyl)borate] ([BARF]), and
n) [(R′—SO₂)₂N]⁻;
wherein R′ is a linear or branched aliphatic or alicyclic alkyl residue or C₅-C₁₈ aryl residue or C₅-C₁₈-aryl-C₁-C₆ alkyl residue or C₁-C₆-alkyl-C₅-C₁₈ aryl residue that contains 1 to 12 carbon atoms and which can be substituted by halogen atoms or oxygen atoms.

7. The process according to claim 6, wherein an ionic liquid is used to render the s-cat inert which has bistrifluoromethylsulfonylimide as the anion.

8. The process according to claim 7, wherein the ionic liquid 1-butyl-3-methylimidazolium bistrifluoromethylsulfonylimide ([BMIM][NTf₂]) is used to render the s-cat inert.

9. A catalyst, which is heterogeneous and not sensitive to oxygen, wherein the catalyst is comprised of an oxygen-sensitive heterogeneous catalyst (s-cat) whose surface is wetted with an ionic liquid.

10. The catalyst according to claim 9, wherein the s-cat is a self-igniting (pyrophoric) catalyst.

11. The catalyst according to claim 9, wherein the s-cat is Raney nickel.

12. The catalyst according to claim 9, wherein the ionic liquid is selected from the group of the following ionic liquids to which the following applies:
ionic liquids are substances of the general formula aA<m+> bB<n−>, wherein a and b are whole numbers and m=1 or m=2 and n=1 or n=2 and a*m=b*n
and the cation A used is selected from the group formed by the following substances:
a) quarternary ammonium cations of the general formula [NRR¹R²R³]⁺;
b) quarternary phosphonium cations of the general formula [PRR1R2R3]⁺;
c) imidazolium cations of the general formula 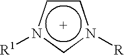
wherein the imidazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
d) pyridinium cations 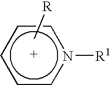
wherein the pyridine core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
e) pyrazolium cation 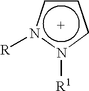
wherein the pyrazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
f) triazolium cation 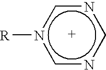
wherein the triazole core can be substituted with at least one group, which is selected from C₁-C₆ alky groups and/or C₁-C₆ alkoxy groups and/or C₁-C₆ amino alkyl groups and/or C₅-C₁₂ aryl- or C₅-C₁₂-aryl-C₁-C₆ alkyl groups;
and in the general formulae the radicals R¹, R² and R³ are selected independent of one another from the group formed by the following substances:
hydrogen;
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
and in the general formulae the radical R is selected from the group formed by the following substances:
linear or branched saturated or unsaturated aliphatic or alicyclic alky groups with 1 to 20 carbon atoms;
heteroaryl-, heteroaryl C₁-C₆ alkyl groups with 3 to 8 carbon atoms in heteroaryl residue and at least one heterocyclic atom selected from N, O and S, which can be substituted with at least one group selected from C₁-C₆ alkyl groups and/or halogen atoms;
aryl-, aryl-C₁-C₆ alkyl groups with 5 to 12 carbon atoms in aryl residue, which can be substituted with at least one C₁-C₆ alkyl group and/or a halogen atom;
and the anion B used is selected from the group formed by the following substances:
a) tetrafluoroborate ([BF₄]⁻),
b) tetrachloroborate ([BCl₄]⁻),
c) hexafluorophosphate ([PF₆]⁻),
d) hexafluoroantimonate ([SbF₆]⁻),
e) hexafluoroarsenate ([AsF₆]⁻),
f) sulfate ([SO₄]²⁻),
g) carbonate ([CO₃]²⁻),
h) fluorosulfonate,
i) [R′—COO]⁻;
j) [R′—SO₃]⁻,
k) [R′—SO₄]⁻,
l) [R′₂PO₄]⁻,
m) [Tetrakis-(3,5-bis-(trifluoromethyl)-phenyl)borate] ([BARF]), and
n) [(R′—SO₂)₂N]⁻;
wherein R′ is a linear or branched aliphatic or alicyclic alkyl residue or C₅-C₁₈ aryl residue or C₅-C₁₈-aryl-C₁-C₆ alkyl residue or C₁-C₆-alkyl-C₅-C₁₈ aryl residue that contains 1 to 12 carbon atoms and which can be substituted by halogen atoms or oxygen atoms.

13. The catalyst according to claim 12, wherein the ionic liquid used to render the s-cat inert has bistrifluoromethylsulfonylimide as the anion.

14. The catalyst according to claim 13, wherein the ionic liquid is 1-butyl-3-methylimidazolium bistrifluoromethylsulfonylimide ([BMIM][NTf₂]).
